(19) United States
(12) Patent Application Publication
(10) Pub. No.: US 2009/0228600 A1
(43) Pub. Date: Sep. 10, 2009

(54) STREAMING CONTENT PROVISIONING SYSTEM FOR WIRELESS NETWORKS

(76) Inventors: Andrew MacFarlane, Denver, CO (US); Mike McKnight, Westminster, CO (US); Garrick Wager, Arvada, CO (US); Ryan Chichirico, Westminster, CO (US)

Correspondence Address: MARSH, FISCHMANN & BREYFOGLE LLP, 8055 East Tufts Avenue, Suite 450, Denver, CO, 80237, US

(21) Appl. No.: 12/249,669

(22) Filed: Oct. 10, 2008

Related U.S. Application Data
(63) Continuation-in-part of application No. 12/053,377, filed on Mar. 21, 2008.
Application No. 12/053,377 is a continuation of application No. 11/853,419, filed on Sep. 11, 2007, now abandoned.
(60) Provisional application No. 60/825,215, filed on Sep. 11, 2006.

(51) Int. Cl. G06F 15/16

(52) U.S. Cl. 709/231

(57) ABSTRACT

A system and method (“utility”) for facilitating the selection of streaming data by, and the delivery of streaming data to, users of mobile devices is provided. The utility includes a network platform for provisioning the streaming content. The system also includes a website that is operable to list or otherwise identify streaming content that is available from one or more content sources, accessing streaming data from the content sources, processing the streaming data (e.g., by associating metadata with the streaming data, associating targeted advertising with the streaming data, transcoding the data, etc.) and delivering the processed streaming data to the end user associated with a mobile device. The system simplifies the process of accessing streaming data, customizes the streaming data for particular users, enhances the streaming data and makes recommendations, and codes the streaming data for different users associated with different devices, different browsers or other software, and different networks.

### CROSS-REFERENCE TO RELATED APPLICATIONS

This application is a continuation in part of U.S. patent application Ser. No. 12/053,377, entitled “STREAMING CONTENT PROVISIONING SYSTEM FOR WIRELESS NETWORK,” filed on Mar. 21, 2008, which is a continuation of U.S. patent application Ser. No. 11/853,419, entitled, “STREAMING CONTENT PROVISIONING SYSTEM FOR WIRELESS NETWORK,” filed on Sep. 11, 2007, which claims priority from U.S. Provisional Application No. 60/825,215, entitled, “STREAMING CONTENT PROVISIONING SYSTEM FOR WIRELESS NETWORK,” filed on Sep. 11, 2006. The contents of the aforementioned applications are incorporated herein as if set forth in full.

### BACKGROUND

Computer networks such as the Internet are increasingly being used to transmit multimedia data (e.g., audio and video data) to users. In the network-based context, one simple model of providing the information involves a user requesting the downloading of the multimedia data to the user's device (e.g., a computer). Once downloaded, the user may then utilize (e.g., view and/or listen to) the information. This model is relatively easy to implement, however, it may not be optimal in that the user is required to wait for the downloading to complete before the use can begin. This delay can be considerable, especially for audio and video data that is relatively large.

A more sophisticated model of providing information to a user involves a content server at a network site streaming the multimedia information over the network to a user at another site (e.g., at home). The user's computer begins to present the information as it arrives (i.e., just-in-time rendering), rather than waiting for the entire data set to arrive before beginning the presentation. At the user's computer, the received data may be buffered into a cache memory and continuously processed as soon as, or soon after, being received by the user's computer. One advantage of streaming is that the user's computer does not have to wait until all the data is downloaded from the server before some of the data is processed and the multimedia output is played.

Recently, advances in network bandwidth, Internet access, and computing power have made streaming media practical and accessible to millions of consumers. As a result, countless Internet sites now provide media that relate to news, sports, entertainment, educational programs, and other types of content.

It is against this background that the streaming content provisioning system for wireless networks has been invented.

### SUMMARY

The present invention is directed to a system for facilitating the selection of streaming data by, and the delivery of streaming data to, users of mobile devices. In particular, the system involves a network platform, e.g., associated with a web site, for provisioning such streaming content. In one implementation, the web site is operative for listing or otherwise identifying streaming content that is available, accessing streaming data from streaming data sources, processing the streaming data (e.g., by associating metadata with the streaming data, associating targeted advertising with the streaming data, transcoding the data, etc.) and delivering the processed streaming data to the end user associated with a mobile device. The invention simplifies the process of accessing streaming data, customizes the streaming data for particular users, enhances the streaming data and makes recommendations, and codes the streaming data for different users associated with different devices, different browsers or other software, and different networks.

In accordance with one aspect of the present invention, a method and apparatus (“utility”) is provided for provisioning streaming data to mobile devices of one or more wireless networks. The utility involves operating a network platform to provide, to a first mobile device, a list of streaming data available from a number of streaming data sources. For example, the list may be generated and stored at the platform, and/or may be displayed at the mobile device. The platform can then receive a request from the first mobile device identifying at least one selection from the list. Responsive to the request, the platform is operative to obtain first streaming data corresponding to the selection (e.g., by accessing at least one streaming data source or retrieving stored streaming data). The platform then processes the first streaming data to provide processed streaming data and makes the processed streaming data available for use by the first mobile device.

The list of streaming data (e.g., as generated and stored at the platform and/or displayed at the mobile device) may be customized for a user of the first mobile device. For example, such customization may be based on stored information regarding the user, such as a user profile. The user profile may be developed based on information explicitly provided by the user, information about the user inferred from streaming data selections, or information obtained from other sources. In addition to the streaming data available from the streaming data sources, the list may include data uploaded by the first user or other users of any supported network. In this regard, it is noted that the platform may service multiple networks and may adapt streaming data for individual users according to their network affiliations (as well as the software and hardware environment of the specific mobile device). The selection indicated in the request may relate to a single item of streaming content from a single source or may relate to multiple items of streaming content available from one or more streaming data sources. For example, the list may include a custom entry for a given user that includes a series of short streams that may be played consecutively. Thus, for a morning commute, a user might concatenate a local weather report, a location-specific traffic report, and last night's baseball scores.

The platform may process the streaming content in a variety of ways. As noted above, the streaming content may be transcoded relative to the mobile device, software environment, network, or the like of the target mobile device. In addition, the platform may store the streaming data or the processed streaming data for a period of time between accessing the data from the data source and delivering the data to the mobile device of the end user. The system may also associate metadata with the streaming data to support a variety of value added functionality. For example, the metadata may identify a target demographic, a location, a subject matter content, or other characteristic associated with the content of the streaming data. Such metadata may be derived from the streaming data, the streaming data source, the end user, or an external source. The metadata can be used to make recommendations regarding streaming data, to select streaming data responsive to a request, to associate targeted advertising with the streaming data, or for a variety of other functions.

The platform may also be used to share data selections from a first user with other system users. For example, a user may wish to share his selections or recommendations with other users, e.g., on a Friend List. It will be appreciated that such lists may already be established in connection with other wireless network services such as instant messaging (IM) services.

In another embodiment, a method is provided for use in receiving content on a mobile device. The method includes first requesting a list of content available from a plurality of content sources from a network platform that is configured to receive communications from mobile devices and to access sources of content. The method also includes receiving the list of content from the network platform, requesting at least one selection of the available content from the list, and receiving the content from the platform on the mobile device.

In another embodiment, a method for forming customized content for use with a mobile device is provided. The method includes selecting a plurality of content from one or more content sources and accessing the plurality of content. The method further includes concatenating the plurality of content into a form that is adapted to be played consecutively, and providing the concatenated content for use by the mobile device.

In another embodiment, a system for provisioning streaming data to mobile devices of one or more wireless networks is provided. The system includes a network platform that is operable to communicate with mobile devices, to access a plurality of sources of streaming data, and to selectively provision processed streaming data to mobile devices. The system further includes a streaming data processor that is operable to process the streaming data into the processed streaming data. Additionally, the system includes a list of streaming data available from the plurality of streaming data sources, wherein the list may be provided to a first mobile device by the network platform, and wherein the processed streaming data may be provisioned to the first mobile device dependent upon a selection from the list.

Additional aspects and corresponding advantages will be apparent to those skilled in the art upon consideration of the further description that follows.

### BRIEF DESCRIPTION OF THE DRAWINGS

FIG. 1 is a schematic diagram of one embodiment of a streaming content provisioning system for wireless networks of the present invention.

FIG. 2 illustrates a user initiated streaming session protocol in accordance with one embodiment of a streaming content provisioning system for wireless networks.

FIG. 3 illustrates a user initiated streaming session protocol in accordance with another embodiment of a streaming content provisioning system for wireless networks.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

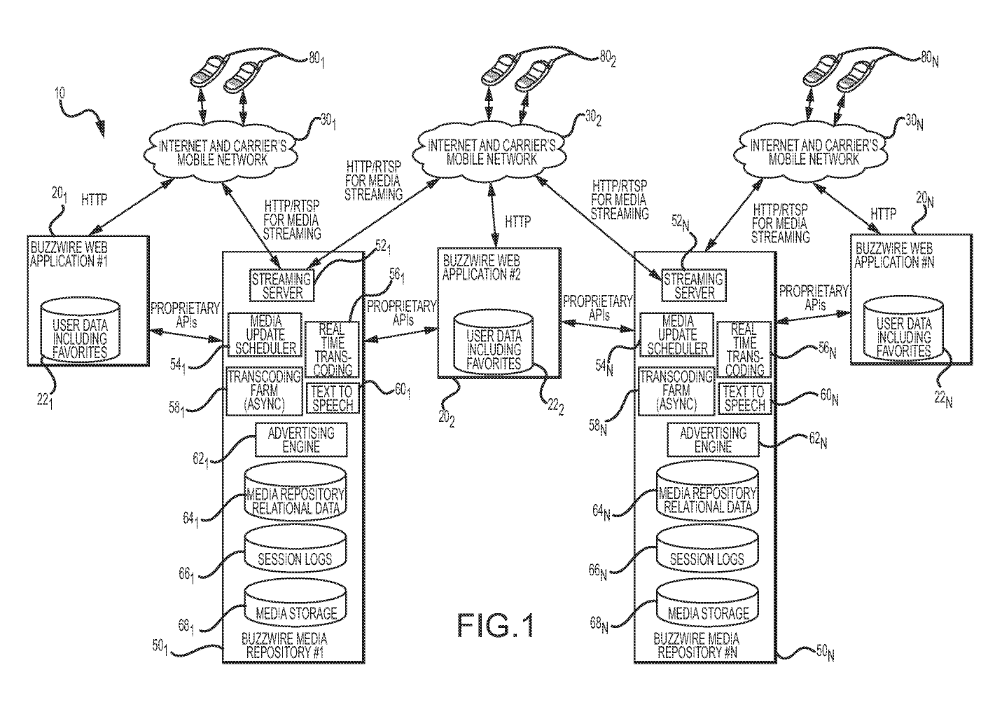

FIG. 1 is a schematic diagram of one embodiment of a streaming content provisioning system 10 for wireless networks. The system 10 includes a plurality of media repositories 50_{1-N} and a plurality of web applications 22_{1-N} that are each coupled to at least one of a plurality of networks 30_{1-N}. The networks 30_{1-N} may include the Internet and one or more wireless mobile networks that are communicatively coupled to the wireless mobile devices 80_{1-N} (e.g., mobile phones, personal digital assistants (PDAs), media players, or the like).

In operation, the system 10 utilizes streaming servers 52_{1-N} to deliver customized streaming data (e.g., audio, video, or the like) to the mobile devices 80_{1-N}. The data may originate outside or inside the system 10. That is, the data may be streamed to mobile devices 80 from the media repositories 50_{1-N} or from external sources such as Internet sites. Further, data may be specific to a user or set of users, or available to all users of the mobile devices 80_{1-N}. Data may be included in a subscription or billed per stream or per delivery, or any combination of the above. The system 10 may allow users to search for content across multiple content sources based on content attributes, including but not limited to genre, region of origin, and language spoken in the content.

The system 10 may deliver data streams to the mobile devices 80 by accessing internal or external content in its native format, then using real-time transcoding modules 56_{1-N} to transcode the stream into the format required by a particular mobile device 80, and deliver the stream via the mechanism required (e.g., a carrier's mobile network) by that device. The system 10 may utilize standard and/or proprietary formats for the streams. In addition, the system 10 may access such content, transcode the stream, and then store the trans-coded stream on media storage modules 68_{1-N} for delivery at a later time when a user requests the data. The system 10 may also include transcoding farms 58_{1-N} that function to asynchronously transcode a plurality of streams into a plurality of formats that may then be stored on the media storage modules 68_{1-N} to be delivered to mobile devices 80 at a later time. Additionally or alternatively, media may be delivered to and stored on a user's mobile device, wherein the user may access the content at any time. As can be appreciated, the availability of this feature may be dependent upon the storage capabilities of the each user's mobile device.

The system 10 may also associate metadata with the streaming data to support a variety of value added functionality. For example, the metadata may identify a target demographic, a location, a subject matter content, or other characteristic associated with the content of the streaming data. Such metadata may be derived from the streaming data itself, the streaming data source (e.g., a website), the end user, or an external source. The metadata can be used to make recommendations regarding streaming data, to select streaming data responsive to a request, to associate targeted advertising with the streaming data, or for a variety of other functions.

The users may be able to watch and/or listen to their selected streams from either the system web application 20 using a computer or on their mobile devices 80. Further, the system web application 20 may allow users to select streams from a list to be available on the mobile device 80. In this regard, users may select one or more streams to be available on their mobile device at a later time. The same selection function may also be done on the mobile devices 80 themselves.

Users may also be provided with the ability to see the streams selected and/or recommended by “friends”, and add those streams to their own lists. The system's web application 20 may also present to the user one or more images of how the user's mobile device 80 will appear once selected streams are provisioned into the user's mobile device 80. The system 10 may also recommend streams to users based on previous streams played, demographics, user-provided preferences, and other information. The system 10 may store streams and information about those streams (e.g. genre, country of origin, language) on the media storage modules 68_{1-N} and the media repository relational data modules 64_{1-N}, respectively.

The web applications 20_{1-N} may also include user data storages 22_{1-N} that stores data about users, including but not limited to: billing information, selected streams, list of friends, user uploaded content, usage information, streams played, start time and duration, location of users when stream are played, subscription information, stream access information, type of device(s) for user, features enabled for user, pause feature, uploading enabled, limits on uploading, mobile device type, and demographics.

The service provider for a user's mobile device 80 may set limits on usage of the system 10, including but not limited to restrictions on total usage over a period of time and/or usage during peak hours. In this regard, the streaming server 52 may check usage limits and permission to access media prior to serving a stream to a user's mobile device 80. As can be appreciated, the system may allow users to subscribe to different limits on usage based on their particular service plans.

The system 10 may also include advertising engines 62_{1-N} that are operable to insert advertising into streams, either before they play a stream, in the middle of a stream, or separate from the stream. The advertising may be targeted for a particular user based on anything the system knows about the user (e.g., types of streams played, user location, user preferences, etc.).

The system 10 may also collect relevant information for billing purposes. The system 10 may deliver this information to a billing system in a format useful to the billing system. In this regard, the billing information may be sent to a plurality of carriers, in multiple formats that are suitable for each carrier.

The system 10 may also allow the user to selectively control the streaming of content. For example, the system may allow the user to pause a stream and resume playing it at a later time. Other example functions that may be provided are rewind, fast-forward, slow play, or the like. The playback control functionality may vary depending on particular mobile devices, individual carriers, or users' subscriptions.

The system may also allow users to upload their own content to the media repositories 50_{1-N}, possibly for an additional fee. Users, from any source (e.g., mobile devices, computers, or the like) may provide the media that is to be uploaded. Additionally, the uploaded content may be available to the uploading user, a subset of users (e.g., “friends”), all users of the system 10, or any combination of the above.

The system 10 may include media update schedulers 54_{1-N} that operate to periodically update the media stored for future playback on the mobile devices 80_{1-N}. For example, the system 10 may periodically retrieve the latest weather or traffic information for multiple locations, such that a user receives the most current information available when they view or listen to the stream on their mobile device.

The system 10 may further include text to speech engines 60_{1-N} that may be utilized to convert text content to audio content. For example, a user may wish to receive a news article or other text from a website. The system 10 may retrieve the article from the website, convert the text to an audio file using the text to speech engine 60, and then stream the audio file to the user's device 80 for playback. As can be appreciated, the content may be retrieved and converted at a time when a user makes a request. Additionally or alternatively, the system 10 may automatically convert selections of text articles to audio files and store them on the media storage 68 for playback by users at a later time. For example, a user may subscribe to a particular set of content that is updated daily (e.g., the text of one or more newspaper's websites). Then, when the user requests to play the content, the system 10 may provide one or more audio streams that include the latest version of the articles on the selected website(s).

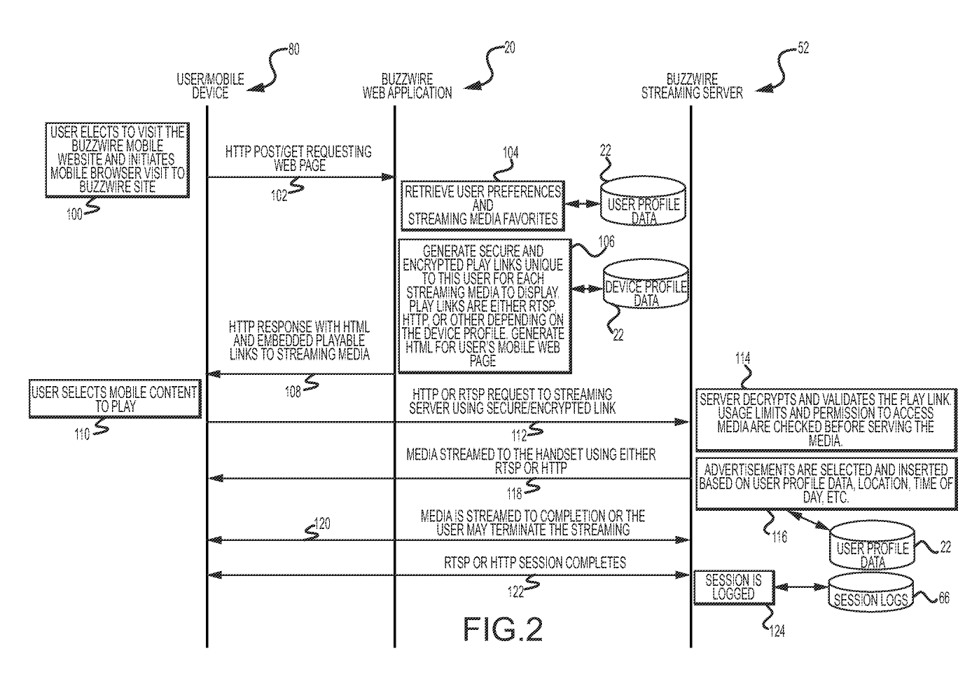

FIG. 2 illustrates a user initiated streaming session protocol in accordance with one embodiment of a streaming content provisioning system for wireless networks, such as the system 10 shown in FIG. 1. In this embodiment, the mobile devices 80 use direct media links to receive streaming media. Initially, a user may use their mobile device 80 to visit the web application 20, step 100. The mobile device 80 may use a native web browser or a proprietary application to access the web application 20. Subsequently, the user's mobile device 80 sends a request to the web application 20 for a list of available streaming media, step 102. In response to this request, the web application 20 may retrieve user preferences and streaming media favorites from the user profile data storage 22, step 104. The web application 20 may then generate secure and encrypted play links that are customized for the requesting user for each streaming media to display on the users mobile device 80, step 106. To determine which protocol(s) is compatible with a particular mobile device 80, the web application 20 may access the device profile data storage 22. For example, the play links may be Real Time Streaming Protocol (RTSP), Hypertext Transfer Protocol (HTTP), or any other standard or proprietary protocol.

Once the user has requested the play links from the web application 20, the web application may respond by providing customized graphical content (e.g., using HTML) to the user's mobile web page, step 108. In turn, the user may utilize the interface on the mobile device 80 to select content to play, step 110. The selection by the user creates a request (e.g., HTTP or RTSP) to the streaming server 52 using a secure/encrypted link, step 112. The streaming server 52 then decrypts and validates the play link selected by the user, step 114.

Prior to serving media to the user's mobile device 80, the streaming server 52 may check any usage limits and/or access requirements. The streaming server 52 may also select and insert advertisements into the content prior to streaming the media to a user's mobile device 80, step 116. As discussed above, the advertisements may be selected dependent upon user profile data, location of the user, time of day, or any other desirable targeting mechanism.

After the optional advertisements have been inserted into the content, the media may then be streamed to the user's mobile device 80, step 118. The media may be streamed by the streaming server 52 until completion, or until the user terminates the streaming by activating one or more controls on the mobile device 80, step 120. After the termination of the media stream, the session completes, step 122, and the session may be logged by the streaming server 52 on the session logs storage 66, step 124.

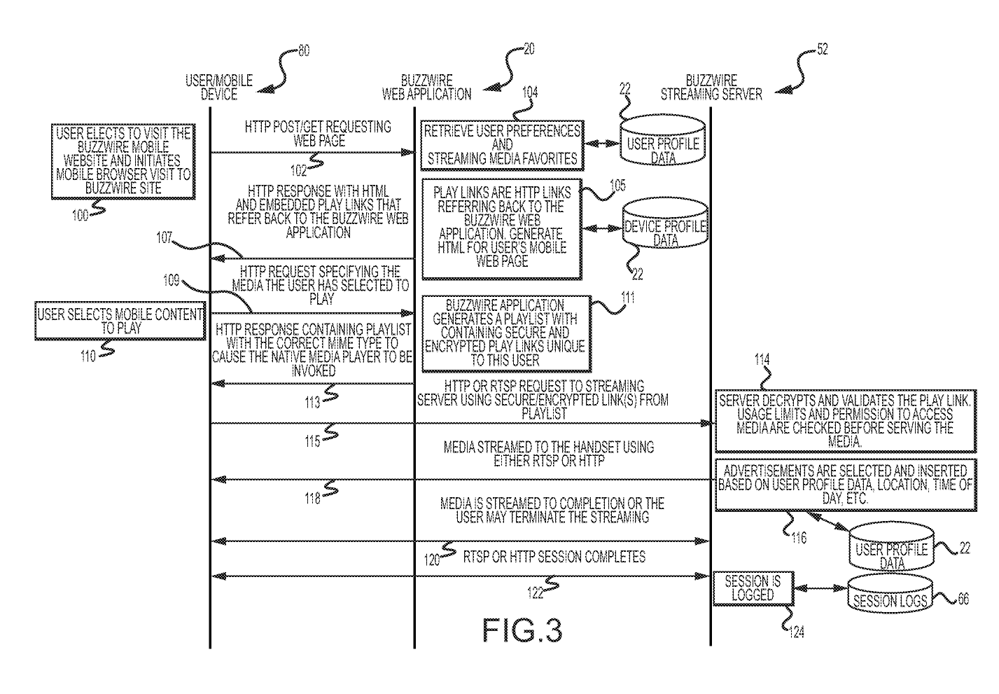

FIG. 3 illustrates a user initiated streaming session protocol in accordance with another embodiment of a streaming content provisioning system for wireless networks. Steps in FIG. 3 that correspond to steps in FIG. 2 are referred to with corresponding reference numerals. In this embodiment, the mobile devices 80 use play lists instead of direct media links to select the media to be streamed to their mobile devices. Initially, a user may use their mobile device 80 to visit the web application 20, step 100. Subsequently, the user's mobile device 80 sends a request to the web application 20 for a list of available streaming media, step 102. In response to this request, the web application 20 may retrieve user preferences and streaming media favorites from the user profile data storage 22, step 104. The web application 20 may then generate play links (e.g., HTTP links) that refer back to the web application, step 105. To determine which format is compatible with a particular mobile device 80, the web application 20 may access the device profile data storage 22.

Once the user has requested the play links from the web application 20, the web application may respond by providing customized graphical content (e.g., using HTML) to the user's mobile web page that contains embedded play links that refer back to the web application 20, step 107. In turn, the user may use the interface on the mobile device 80 to select content to play, step 110. The selection by the user creates a request (e.g., HTTP) to the web application that specifies the media that the user has selected to play, step 109. The web application 20 then generates a play list that contains secure and encrypted play links that are unique to the particular requesting user, step 111, and sends an HTTP response to the mobile device 80 containing the play list, step 113. The web application 20 may ensure that the play lists are sent with the proper internet media type (also known as MIME type) for the particular mobile device 80 such that the device's native media player will be invoked.

The media player of the mobile device 80 may then send a request (e.g., HTTP or RTSP) to the streaming server 52 using secure and/or encrypted link(s) from the play list, step 115. Prior to serving the media to the user's mobile device 80, the streaming server 52 may check any usage limits and/or permission to access requirements, step 114. The streaming server 52 may also select and insert advertisements into the content prior to streaming the media to a user's mobile device 80, step 116. As discussed above, the advertisements may be selected dependent upon user profile data, location of the user, time of day, or any other desirable targeting mechanism.

After the optional advertisements have been inserted into the content, the media may then be streamed to the user's mobile device 80, step 118. The media may be streamed by the streaming server 52 until completion, or until the user terminates the streaming using the mobile device 80, step 120. After the termination of the media stream, the session completes, step 122, and the session is logged by the streaming server 52 on the session logs storage 66, step 124.

Each user may also be allowed to configure a list of “friends.” If a “friend” user consents, the original user and the friend will be able to share selected information. This information could include, but not be limited to: a list of recommended streams, a list of streams most played by a user, the selected list of streams for each user, a list of streams most recently played by a user, whether a user is currently listening to a stream, or the like.

A user may also be able to select and add to his/her list of streams any stream that appears in a list of a “friend.” Users can personalize their selections on the system's website by searching the available content, and selecting particular stations (or other streaming content) to appear on their mobile devices (again on the web), and then select how the service provides updates that show up automatically on the users' devices (e.g., what data is sent and when).

The system may also be operable to provide a selection of short streams played consecutively—the idea being that users can tailor a set of short pieces of content that are relevant for them. For instance, for a morning commute a user might concatenate a weather report, a location-specific traffic report, and last night's baseball scores.

Users will have the ability to create these concatenated streams using the web interface. Additionally or alternatively, the system or other users could create the streams for them automatically. The system may be intelligent enough to substitute the latest version of a certain time-sensitive stream when a stream is requested. For example, if a user subscribes to I-25 traffic the system will play the latest traffic update whenever the stream is selected. Further, the system will make the content as fine-grained as possible. For example, separate traffic reports may be provided for multiple areas of a town, or sports to a specific team.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A method for use in provisioning streaming data to mobile devices of one or more wireless networks, comprising the steps of:
providing a network platform for receiving communications from mobile devices and accessing sources of streaming data;
first operating said platform to provide, to a first mobile device, a list of streaming data available from a plurality of said streaming data sources;
receiving, at said platform, a request from said first mobile device, said request identifying at least one selection from said list of streaming data;
second operating said platform, responsive to said request, to obtain first streaming data corresponding to said selection;
third operating said platform to process said first streaming data to provide processed streaming data; and
fourth operating said platform to provide said processed streaming data for use by said first mobile device.

2. A method as set forth in claim 1, wherein said step of first operating comprises providing said list of streaming data wherein said list is customized for a user of said first mobile device.

3. A method as set forth in claim 2, wherein said list is customized for said user based on stored information regarding said user.

4. A method as set forth in claim 2, wherein said list includes at least one item of streaming data uploaded to said platform by a user of one of said wireless networks.

5. A method as set forth in claim 4, wherein said item of streaming data was uploaded to said platform by said user.

6. (canceled)

7. A method as set forth in claim 1, wherein said selection corresponds to multiple items of streaming content available from one or more of said streaming data sources.

8. A method as set forth in claim 1, wherein said step of third operating comprises transcoding said streaming data for use by said first mobile device.

9-12. (canceled)

13. A method as set forth in claim 1, further comprising the steps of:
receiving, at said platform, a second request from a second mobile device;
operating said platform, responsive to said second request, to access streaming data corresponding to said second request; and
operating said platform to process said second streaming data to provide a second processed streaming data and to provide said second processed streaming data for use by said second mobile device.

14. A method as set forth in claim 13, wherein said first mobile device is associated with a first wireless network and said second mobile device is associated with a second wireless network different than said first wireless network.

15. A method as set forth in claim 1, further comprising the step of associating metadata with at least one item of streaming data from said list of streaming data.

16-21. (canceled)

22. A method as set forth in claim 1, further comprising the step of operating said platform to share information from said first user to one or more second users regarding said streaming data.

23-36. (canceled)

37. A method for use in receiving content on a mobile device, comprising the steps of:
first requesting a list of content available from a plurality of content sources from a network platform that is configured to receive communications from mobile devices and to access sources of content;
first receiving said list of content from said platform;
second requesting at least one selection of said available content from said list; and
second receiving said content from said platform on said mobile device.

38. The method as set forth in claim 37, further comprising the step of playing said content on said mobile device.

39. The method as set forth in claim 37, wherein said step of second requesting comprises requesting multiple selections of said available content.

40. The method as set forth in claim 37, wherein the content received comprises a concatenation of content from said plurality of content sources.

41. The method as set forth in claim 40, wherein the concatenated content includes content from at least two of said plurality of content sources.

42. The method as set forth in claim 37, further comprising the step of sharing one of said list and said content with a user associated with a second mobile device.

43. (canceled)

44. The method as set forth in claim 37, wherein said content is streaming content.

45-46. (canceled)

47. The method as set forth in claim 37, further comprising the step of uploading content to said network platform, wherein said uploaded content is then available for use by one or more mobile devices.

48. The method as set forth in claim 47, wherein said step of uploading content to said network platform is performed by a first mobile device, and wherein said uploaded content is then available for use by a second mobile device different from said first mobile device.

49. A method for forming customized content for use with a mobile device, the method comprising the steps of:
selecting a plurality of content from one or more content sources;
accessing said plurality of content;
concatenating said plurality of content into a form that is adapted to be played consecutively, and
providing said concatenated content for use by said mobile device.

50. The method as set forth in claim 49, wherein at least one of the plurality of content includes streaming content.

51. (canceled)

52. The method as set forth in claim 49, wherein said selecting step includes the steps of:
providing, to a first mobile device, a list of available content from said one or more content sources;
in response to a request from said first mobile device, determining content associated with said request.

53. (canceled)

54. The method as set forth in claim 53, wherein said step of processing includes formatting the content into a form that is playable by said mobile device.

55. The method as set forth in claim 49, further comprising the step of inserting one or more advertisements into said concatenated content.

56-61. (canceled)

62. A system for provisioning streaming data to mobile devices of one or more wireless networks, the system comprising:
a network platform that is operable to communicate with mobile devices, to access a plurality of sources of streaming data, and to selectively provision processed streaming data to mobile devices;
a streaming data processor that is operable to process said streaming data into said processed streaming data; and
a list of streaming data available from said plurality of streaming data sources, wherein said list may be provided to a first mobile device by said network platform, and wherein said processed streaming data may be provisioned to said first mobile device dependent upon a selection from said list.

63. A system as set forth in claim 62, wherein said list of streaming data is customized for a user of said first mobile device.

64. (canceled)

65. A system as set forth in claim 63, wherein said list includes at least one item of streaming data uploaded to said network platform by a user of one of said one or more wireless networks.

66-67. (canceled)

68. A system as set forth in claim 62, wherein said selection corresponds to multiple items of streaming data available from one or more of said plurality of streaming data sources.

69-93. (canceled)
